(19) United States
(12) Patent Application Publication
(10) Pub. No.: US 2026/0320178 A1
(43) Pub. Date: Oct. 15, 2026

(54) AUTONOMOUS PENTESTING UTILIZING SHORTEST PATH ANALYSIS

(71) Applicant: Horizon 3 AI, Inc., Dover, DE (US)

(72) Inventor: Joshua Foster, Ellicott City, MD (US)

(21) Appl. No.: 19/177,353

(22) Filed: Apr. 11, 2025

(51) Int. Cl. G06F 21/55

(52) U.S. Cl. CPC G06F 21/554; G06F 2221/034

(57) ABSTRACT

An autonomous pentesting agent may execute an autonomous pentest of a tenant environment of a software platform, where the autonomous pentest includes compromising a credential associated with a user account of the tenant environment. The agent may obtain, based on compromising the credential, an indication of an attack path between the user account associated with the credential and a compromise event, the attack path indicating a sequence of network assets and one or more edges between the network assets. The attack path may be one of multiple possible attack paths between the user account and the compromise event and include a smallest numerical quantity of edges of the multiple possible attack paths. The agent may retrieve mappings between one or more autonomous pentesting operations and the one or more edges and execute, based on retrieving the mappings, the one or more autonomous pentesting operations in accordance with the attack path.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support autonomous pentesting utilizing shortest path analysis.

In some aspects, the techniques described herein relate to a method for autonomous pentesting using shortest path analysis, including: executing an autonomous pentest of a tenant environment of a software platform including a plurality of network assets, wherein the autonomous pentest includes compromising a credential associated with a user account of the tenant environment; obtaining, based at least in part on compromising the credential, an indication of an attack path between the user account associated with the credential and a compromise event, the attack path indicating a sequence of network assets of the plurality of network assets and one or more edges between network assets in the sequence of network assets, wherein: the attack path is one of a plurality of possible attack paths between the user account and the compromise event, each path of the plurality of possible attack paths associated with different sequences of respective quantities of edges between network assets, and the attack path includes a smallest numerical quantity of edges of the respective quantities of edges; retrieving, based at least in part on receiving the indication of the attack path, one or more mappings between one or more autonomous pentesting operations and the one or more edges; and executing, based at least in part on retrieving the one or more mappings, the one or more autonomous pentesting operations in accordance with the attack path.

In some aspects, the techniques described herein relate to an apparatus for autonomous pentesting using shortest path analysis, including: one or more memories storing processor-executable code; and one or more processors coupled with the one or more memories and individually or collectively operable to execute the code to cause the apparatus to: execute an autonomous pentest of a tenant environment of a software platform including a plurality of network assets, wherein the autonomous pentest includes compromising a credential associated with a user account of the tenant environment; obtain, based at least in part on compromising the credential, an indication of an attack path between the user account associated with the credential and a compromise event, the attack path indicating a sequence of network assets of the plurality of network assets and one or more edges between network assets in the sequence of network assets, wherein: the attack path is one of a plurality of possible attack paths between the user account and the compromise event, each path of the plurality of possible attack paths associated with different sequences of respective quantities of edges between network assets, and the attack path includes a smallest numerical quantity of edges of the respective quantities of edges; retrieve, based at least in part on receiving the indication of the attack path, one or more mappings between one or more autonomous pentesting operations and the one or more edges; and execute, based at least in part on retrieving the one or more mappings, the one or more autonomous pentesting operations in accordance with the attack path.

In some aspects, the techniques described herein relate to a non-transitory computer-readable medium storing code for autonomous pentesting using shortest path analysis, the code including instructions executable by one or more processors to: execute an autonomous pentest of a tenant environment of a software platform including a plurality of network assets, wherein the autonomous pentest includes compromising a credential associated with a user account of the tenant environment; obtain, based at least in part on compromising the credential, an indication of an attack path between the user account associated with the credential and a compromise event, the attack path indicating a sequence of network assets of the plurality of network assets and one or more edges between network assets in the sequence of network assets, wherein: the attack path is one of a plurality of possible attack paths between the user account and the compromise event, each path of the plurality of possible attack paths associated with different sequences of respective quantities of edges between network assets, and the attack path includes a smallest numerical quantity of edges of the respective quantities of edges; retrieve, based at least in part on receiving the indication of the attack path, one or more mappings between one or more autonomous pentesting operations and the one or more edges; and execute, based at least in part on retrieving the one or more mappings, the one or more autonomous pentesting operations in accordance with the attack path.

### BRIEF DESCRIPTION OF THE DRAWINGS

FIG. 1 shows an example of a computing environment that supports autonomous pentesting utilizing shortest path analysis in accordance with aspects of the present disclosure.

FIG. 2 shows an example of an autonomous pentest map that supports autonomous pentesting utilizing shortest path analysis in accordance with aspects of the present disclosure.

FIG. 3 shows an example of a computing environment that supports autonomous pentesting utilizing shortest path analysis in accordance with aspects of the present disclosure.

FIG. 4 shows an example of a flow diagram that supports autonomous pentesting utilizing shortest path analysis in accordance with aspects of the present disclosure.

FIG. 5 shows an example of a computing system that supports autonomous pentesting utilizing shortest path analysis in accordance with aspects of the present disclosure.

FIGS. 6 and 7 show examples of process flows that support autonomous pentesting utilizing shortest path analysis in accordance with aspects of the present disclosure.

FIG. 8 shows a diagram of a system including a device that supports autonomous pentesting utilizing shortest path analysis in accordance with aspects of the present disclosure.

FIG. 9 shows a flowchart illustrating methods that support autonomous pentesting utilizing shortest path analysis in accordance with aspects of the present disclosure.

### DETAILED DESCRIPTION

During an autonomous pentest of an environment, an autonomous pentesting agent may perform operations to identify weaknesses or vulnerabilities in the environment that may be exploited by an attacker to achieve compromise events. For example, the autonomous pentesting agent may perform operations along an attack path to achieve a compromise event. In some cases, the attack path may involve more than one compromise event. As an example, the autonomous pentesting agent may compromise a credential associated with a user account, then use the compromised credential to compromise a computing device, which may be used to compromise another computing device, and so on. Additionally, there may be more than one possible attack path to compromise events. That is, the autonomous pentesting agent may identify weaknesses or vulnerabilities that lead to compromise events in multiple different ways. The autonomous pentesting agent may utilize one or more artificial intelligence (AI) models to identify operations to execute during the pentest, and, accordingly, autonomous pentests of a same environment may expose different weaknesses or vulnerabilities and/or involve different attack paths.

A path identification service may generate representations of relationship structures for some environments, such as tenant environments of software platforms including Active Directory tenant environments, Microsoft Entra ID tenant environments, Azure Active Directory tenant environments, or the like. Tenant environments of software platforms may include webs of permissions between different objects (e.g., user accounts, groups, machines, etc.). As an example, a tenant environment may include a user account that is a member of one or more groups, has administrative privileges to one or more machines or services, or both. The path identification service may generate a representation of these webs of permissions. For example, the representation may include an edge between the user account and the one or more groups, where the edge indicates that the user account is a member of the one or more groups. That is, the representation may include nodes corresponding to objects in the tenant environment and edges between the nodes indicating their relationships.

In examples in which the autonomous pentesting agent performs an autonomous pentest of a tenant environment of a software platform, the autonomous pentesting agent may use the path identification service to identify a set of one or more shortest attack path(s), which may reduce resource overhead and improve a speed of the autonomous pentest. For example, when the autonomous pentesting agent compromises a credential of a user account in the tenant environment, the autonomous pentesting agent may obtain, via the path identification service, a shortest attack path from the user account to a compromise event. As used herein, a “shortest” attack path may refer to an attack path having the fewest edges of possible attack paths between the user account and the compromise event. The autonomous pentesting agent may retrieve mappings between edges of the shortest attack path and corresponding autonomous pentesting operations and attempt to execute the autonomous pentesting operations to achieve the compromise event. Using the shortest attack path may improve resource utilization and allow the autonomous pentesting agent to expose weaknesses and vulnerabilities in the tenant environment more quickly compared to using the one or more AI models to identify operations during autonomous pentesting.

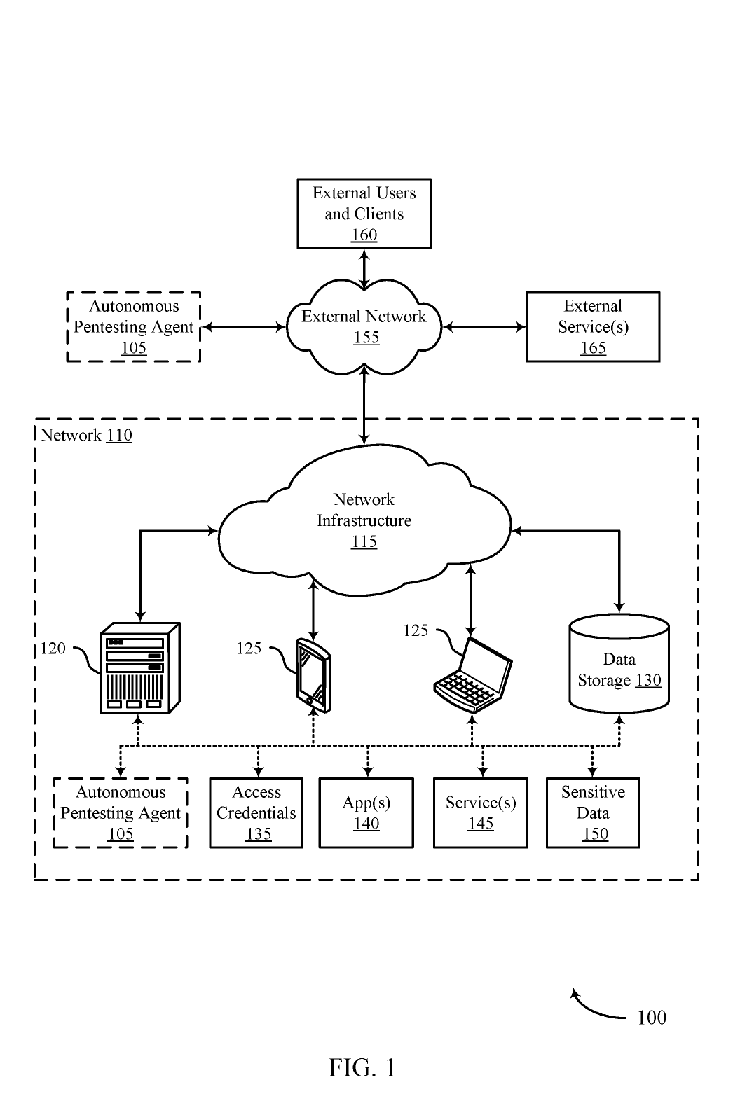

FIG. 1 illustrates an example of a computing environment 100 that supports autonomous pentesting utilizing shortest path analysis in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein network assets refer to data, devices, or components of the network 110, including software and hardware. In some examples, network assets may refer to machines that include network shares. For example, network assets may be examples of machines (e.g., real or virtual machines) that include shares of the network 110, such as file sharing systems. Network assets may be obtained and utilized by attackers to compromise the network 110. In some cases, network assets may refer to network entities (i.e., system hosts/machines) that have internet protocol (IP) addresses and may be discovered during scans. The server 120, the computing devices 125 (e.g., laptops, desktops, and mobile devices, smart vehicles, wearables, etc.), the data storage 130, and the access credentials 135, app(s) 140, service(s) 145, cookies, encryption and decryption keys, tokens, and sensitive data 150 accessible via the devices and systems of the network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

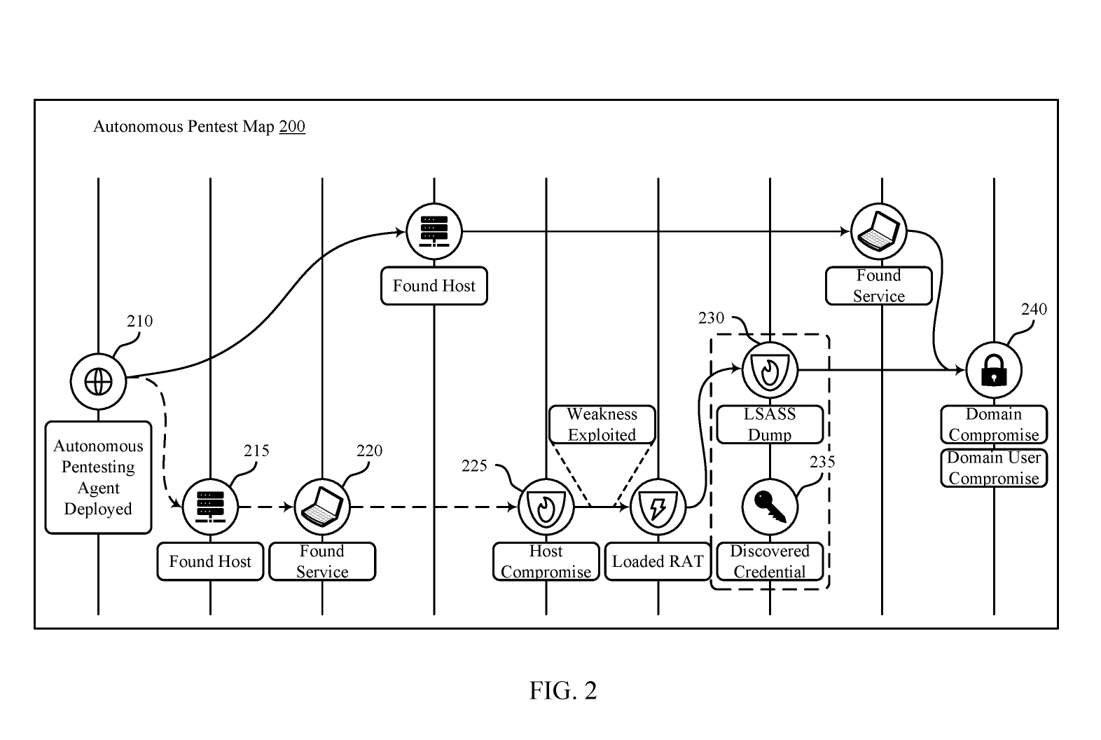

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more AI models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155. In some examples, the autonomous pentesting agent 105 may be deployed via a runner. For example, a runner may be an executable process, script, or sequence, that enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, the autonomous pentesting agent may use shortest path analysis during an autonomous pentest of the network 110. For example, the network 110 may include or be an example of a tenant environment of a software platform including multiple network assets (or allowing access to the network assets of the network 110). The autonomous pentesting agent 105 may execute an autonomous pentest of the tenant environment, including compromising access credentials 135 associated with a user account of the tenant environment. The autonomous pentesting agent 105 may obtain an indication of a shortest attack path between the user account associated with the access credentials 135 and a compromise event. Based on the indication of the shortest attack path, the autonomous pentesting agent 105 may retrieve mappings between edges of the shortest attack path and autonomous pentesting operations. That is, the autonomous pentesting agent 105 may store mappings between edges and corresponding autonomous pentesting operations. The autonomous pentesting agent 105 may execute the autonomous pentesting operations to traverse the edges of the shortest attack path.

By obtaining and executing autonomous pentesting operations corresponding to the shortest attack path, the autonomous pentesting agent 105 may execute the autonomous pentest of the tenant environment more quickly (e.g., compared to executing simply a possible attack path, which may not be a shortest attack path). For example, by leveraging attack paths that have defined autonomous pentesting operations to execute (rather than the autonomous pentesting agent 105 using one or more AI models to determine what to do next) the autonomous pentesting agent 105 may execute the autonomous pentest with improved efficiency. Additionally, the autonomous pentesting agent 105 may obtain attack paths to achieve different types of compromise events, ensuring efficiency for targeted pentests.

FIG. 2 shows an example of an autonomous pentest map 200 that supports autonomous pentesting utilizing shortest path analysis in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support the identification of shortest attack paths. For example, the autonomous pentest map 200 may include a shortest attack path between the credential identification 235 and the access 240 (e.g., domain compromise). The autonomous pentesting service may obtain the shortest attack path from multiple possible attack paths between the credential identification 235 and the access 240, where the shortest attack path includes a lowest numerical quantity of edges (e.g., connections between events on the autonomous pentest map 200) of the multiple possible attack paths. The edges of the attack path may correspond to autonomous pentesting operations. For example, an edge between the credential identification 235 and the access 240 may be mapped to an autonomous pentesting operation including one or more modules (e.g., of executable code). The autonomous pentesting service may execute the autonomous pentesting operation to traverse the edge between the credential identification 235 and the access 240 (e.g., to achieve domain and/or domain user compromise).

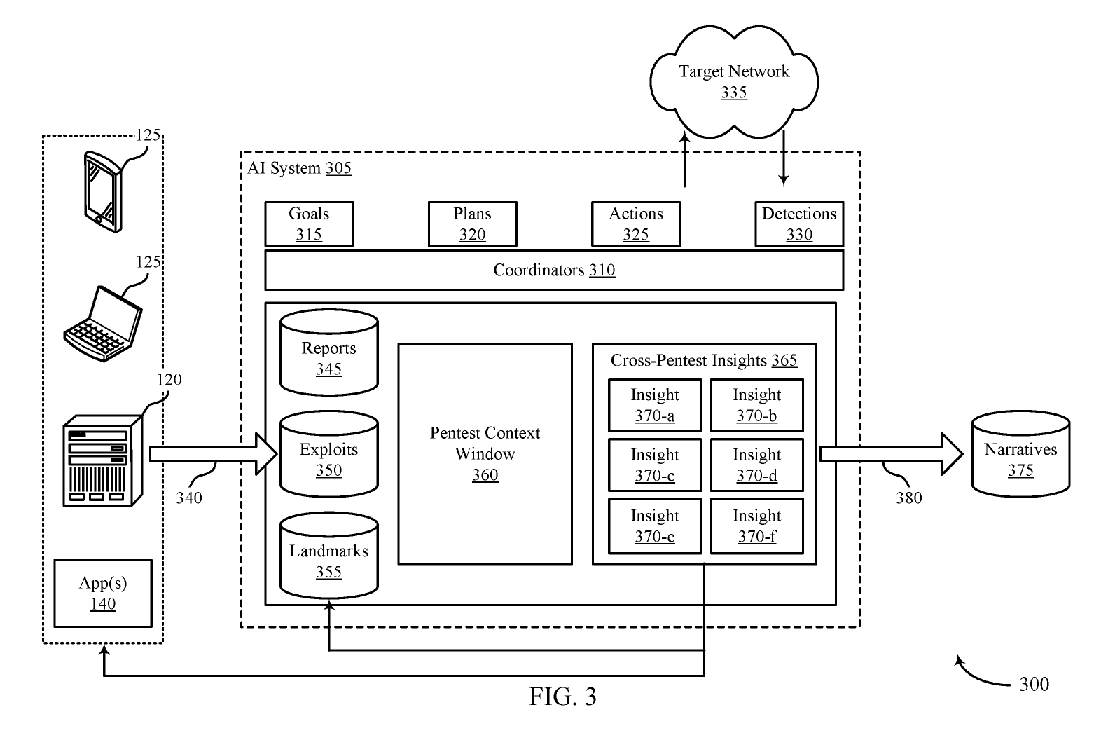

FIG. 3 shows an example of a computing environment 300 that supports autonomous pentesting utilizing shortest path analysis in accordance with aspects of the present disclosure. The computing environment 300 may implement or be implemented by the computing environment 100, the autonomous pentest map 200, or both. For example, the computing environment 300 may illustrate servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions. In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously, at least for some operations, to achieve specified goals, make decisions, and take actions without direct human intervention (e.g., through the use of AI agents). In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a network 110, compromise (such as by obtaining unauthorized administrative access or deploying unauthorized software to) a domain or a network asset of the network 110, or any combination thereof. To obtain the goals 315, the AI system 305 may generate one or more plans 320 that are based on actions 325 and detections 330. For example, to determine a next best action within a defined set of guardrails or instructions, the AI system 305 may generate a plan 320 that can include an action 325 to invoke (e.g., execute) one or more commands on a target network 335 to obtain a detection 330 from the target network 335.

In some examples, the target network may include one or more network assets such as servers 120, computing devices 125, data storages 130, app(s) 140, or any combination thereof. Further, obtaining a detection 330 from the target network 335 may include the AI system 305 retrieving telemetry data from the one or more network assets of the target network 335. In some cases, telemetry data obtained from the target network 335 may include logs, traces, metrics, events, or any combination thereof from the one or more network assets of the target network 335. For example, a detection 330 may include some data that is obtained from the target network 335 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 335, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, or billions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 thar resulted in the action 325 succeeding or failing, or any combination thereof. Therefore, the AI system 305 may continuously obtain and update the training data used for training AI/ML models and perform reinforcement learning using collective intelligent to improve the weights and training of the AI/ML models.

In some examples, the training data for the AI system 305 may include telemetry data obtained from the target network 335, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 335) to assist the AI system 305 to navigate and map a target environment during an autonomous pentest.

In some examples, the AI system 305 may obtain the reports 345, exploits 350, and landmarks 355 based on performing one or more autonomous pentests. In another example, one or more users (e.g., developers) manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by proving the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 335, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentests, including successfully exploited vulnerabilities, accessed systems and data, attempted but failed exploit paths, among others.

In some examples, the AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in commonly used enterprise software. In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant network compromise. Therefore, the cross-pentest insights 365 may indicate one or more insights 370 that represent patterns and vulnerabilities that occur across different networks and testing scenarios, helping organizations better understand systemic security weaknesses that need to be addressed. For example, the cross-pentest insights 365 may be added as landmarks 355 for further training the AI system 305 to perform autonomous pentests.

In some examples, the cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a network 110. In another example, a narrative 375 may be a presentation for a company or organization that indicates the one or more vulnerabilities in a network 110 associated with the company or organization. For example, the presentation can indicate the cross-pentest insights 365 obtained from performing one or more autonomous pentests on the network 110 associated with the company or organization (e.g., the target network 335).

An autonomous pentesting service may utilize the AI system 305 to execute autonomous pentesting operations associated with a shortest attack path from a user account to a compromise event within a tenant environment. For example, the autonomous pentesting service may, after obtaining the shortest attack path, retrieve autonomous pentesting operations corresponding to edges of the attack path. The autonomous pentesting service may use the AI system 305 to retrieve and execute the autonomous pentesting operations.

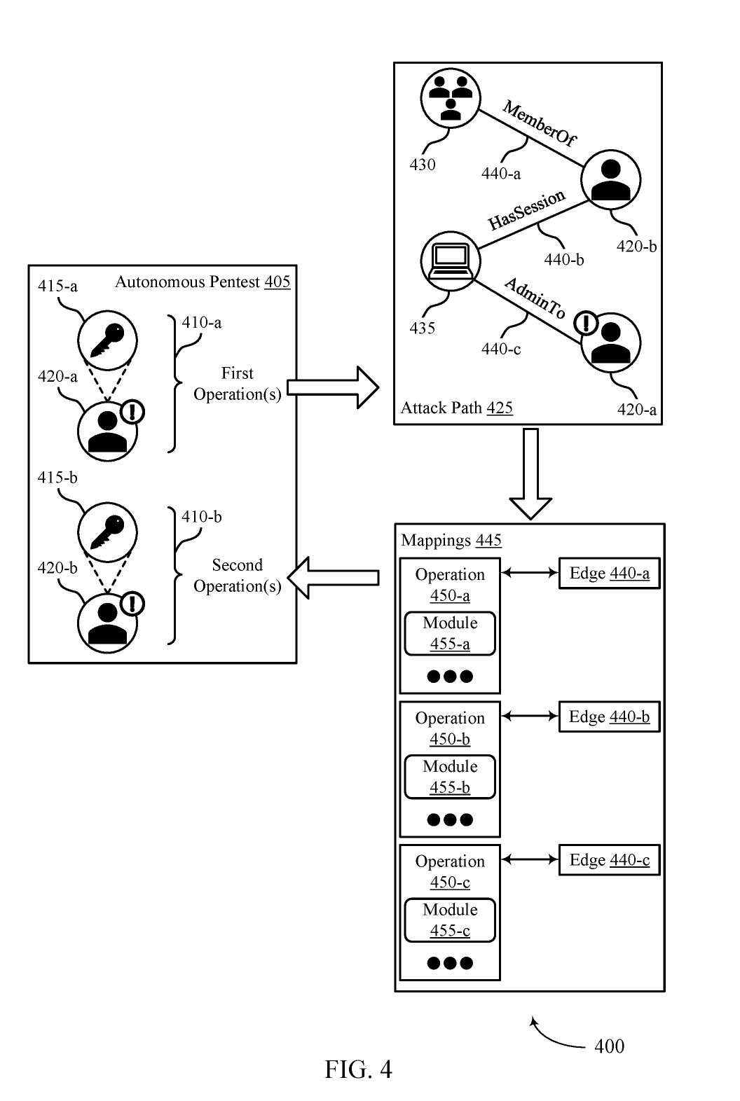

FIG. 4 shows an example of a flow diagram 400 that supports autonomous pentesting utilizing shortest path analysis in accordance with aspects of the present disclosure. The flow diagram 400 may implement or be implemented by the computing environment 100, the autonomous pentest map 200, the computing environment 300, or any combination thereof. For example, the flow diagram 400 may illustrate operations by an autonomous pentesting agent 105, such as the autonomous pentesting agent 105 as described with reference to FIG. 1.

An autonomous pentesting agent may execute an autonomous pentest 405 of a tenant environment of a software platform. For example, the autonomous pentesting agent may be deployed in the tenant environment for the autonomous pentest 405. The tenant environment may be an example of an Active Directory environment, a Microsoft Entra ID environment, as an Azure Active Directory, or the like. For example, the tenant environment may include network assets—such as user accounts, machines, and the like—which may have relationships with each other. That is, the software platform may support membership and permissions structures that define what network assets users may access, which user accounts are permitted to manage memberships and permissions, inclusion of user accounts in groups, and the like.

The autonomous pentesting agent may perform first operation(s) 410-a as part of the autonomous pentest 405. The first operation(s) 410-a may include compromising a credential 415-a (e.g., a domain credential) associated with a user account 420-a. That is, the autonomous pentesting agent may execute the autonomous pentest 405 of the tenant environment of the software platform including multiple network assets, where the autonomous pentest 405 includes compromising a credential 415-a associated with a user account 420-a of the tenant environment. As used herein, credentials “associated with” or “of” user accounts may refer to credentials used to log in to or access user accounts or network assets accessible via user accounts.

After compromising the credential 415-a, the autonomous pentesting agent may perform shortest path analysis to determine a subsequent operation of the autonomous pentest 405. For example, the autonomous pentesting operation may obtain, based on compromising the credential 415-a, an attack path 425 between the user account 420-a associated with the credential 415-a and a domain administrator group 430 corresponding to or representing a compromise event. The attack path 425 may be an example of a directional graph and may start at the user account 420-a and end at the domain administrator group 430.

According to the attack path 425, the domain administrator group 430 may include a user account 420-b (e.g., the user account 420-b may be a member of the domain administrator group 430) via an edge 440-a. That is, the edge 440-a may be indicative of a MemberOf relationship between the domain administrator group 430 and the user account 420-b. The attack path 425 may also include a machine 435 (e.g., a Windows eXPerience (XP) machine) that the user account 420-a has a session with via an edge 440-b. That is, the edge 440-c may be indicative of a HasSession relationship between the user account 420-b and the machine 435. Finally, the attack path 425 may include the user account 420-a that is an administrator to the machine 435 via the edge 440-c. That is, the edge 40-c may be indicative of an AdminTo relationship between the user account 420-a and the machine 435.

The attack path 425 may be an example of a shortest attack path between the user account 420-a and a compromise event in which the autonomous pentesting agent compromises the domain administrator group 430 (e.g., full domain compromise). The autonomous pentesting agent may, after compromising the credential 415-a, identify a node corresponding to the credential 415-a in a graph of the entire tenant environment and run a query of a shortest attack path between the credential 415-a and a node representing an impact (e.g., a network asset that, if accessed, constitutes a compromise event). As an example, the node representing the impact for a domain compromise event may be a domain administrator. In some examples, the autonomous pentesting agent may transmit a request (e.g., an application programming interface (API) call) to a server (e.g., an API service) with data collected during the first operation(s) 410-a of the autonomous pentest 405. The request may be for a shortest attack path to a compromise event (e.g., domain compromise) from a network asset compromised via the first operation(s) 410-a of the autonomous pentest 405. In response to the request, the autonomous pentesting agent may receive an indication of the attack path 425. Put another way, the autonomous pentesting agent may obtain the attack path 425 based on transmitting a request and receiving a response with an indication of the attack path 425.

As used herein, a “shortest” attack path may refer to an attack path with a lowest numerical quantity of edges. For example, the shortest attack path may, compared to other possible attack paths between a given credential and compromise event, include a lowest quantity of “hops” or edges between nodes (e.g., between network assets). That is, there may be multiple possible attack paths between the user account 420-a and the compromise event, where the multiple possible attack paths include respective quantities of edges, and where the shortest attack path includes the lowest numerical quantity of edges of the respective quantities of edges. While three edges are shown in the example of FIG. 4, it is understood that an attack path may include any numerical quantity of edges.

The autonomous pentesting agent may retrieve autonomous pentesting operations mapped to the edge 440-a, the edge 440-b, and the edge 440-c of the attack path 425. For example, the autonomous pentesting agent may retrieve mappings 445 where the edge 440-a is mapped to an operation 450-a (e.g., in a first mapping), the edge 440-a is mapped to an operation 450-b (e.g., in a second mapping), and the edge 440-c is mapped to an operation 450-c (e.g., in a third mapping). The mappings 445 may include a quantity of mappings corresponding to a quantity of edges in the attack path 425.

The autonomous pentesting agent may store a file including multiple mappings between operations and edges. For example, the autonomous pentesting agent may store a configuration file that maps (e.g., includes mappings between) different edges to operations that the autonomous pentesting agent may perform to traverse them. Each operation may include one or more modules having a sequence (e.g., a chain of modules). For example, the operation 450-a may include a module 455-a, the operation 450-b may include a module 455-b, and the operation 450-c may include a module 455-c. Modules of an operation may describe how to traverse an edge that the operation is mapped to. As an example, an edge may be from a user account to a computing device. The operation mapped to the edge may include a server message block (SMB)_check_perms module that may be used to verify permissions of a credential of the user account, which then may be used to compromise a target computing device (e.g., a target host).

The autonomous pentesting agent may execute the operation(s) mapped to the edges of the attack path 425. For example, the autonomous pentesting agent may continue the autonomous pentest 405 by executing second operation(s) 410-b, which may include operation 450-a (mapped to the edge 440-a), operation 450-b (mapped to the edge 440-b), and operation 450-c (mapped to edge 440-c). Put another way, the autonomous pentesting agent may traverse the attack path 425 edge by edge. If the autonomous pentesting agent successfully executes the module 455-a of an operation 450-a, the autonomous pentesting agent may have effectively traversed the edge 440-a in the attack path 425. After traversing the edge 440-a, the autonomous pentesting agent may continue to the operation 450-b corresponding to the edge 440-b (e.g., a next edge in the attack path 425).

In some examples, the autonomous pentesting agent may skip one or more operations of the second operation(s) 410-b. For example, before performing each operation of the second operation(s) 410-b, the autonomous pentesting agent may check whether the operation has already been executed (e.g., during a prior operation of the second operation(s) 410-b or during the first operation(s) 410-a). If the autonomous pentesting agent has already executed an operation, it may skip to a next operation in the attack path 425.

The autonomous pentesting agent may continue performing the operations of the second operation(s) 410-b until the autonomous pentesting agent fails to execute an operation or until the compromise event (e.g., compromising credentials 415-b) is achieved. That is, the autonomous pentesting agent may, if an operation fails, terminate an attempt to execute the attack path 425. In such examples, the autonomous pentesting agent may attempt to execute a different attack path or conclude the autonomous pentest 405. Alternatively, the autonomous pentesting agent may conclude the autonomous pentest 405 after successfully executing the second operation(s) 410-b and achieving the compromise event. In some examples, the autonomous pentesting agent may identify another attack path starting from the compromise event. For example, the autonomous pentesting agent, continuing the autonomous pentest 405, may obtain a shortest attack path from the compromise event, retrieve mappings between edges of the attack path and autonomous pentesting operations, and execute the autonomous pentesting operations. In another example, the autonomous pentesting agent may continue the autonomous pentest 405 by proceeding with other operations, such as operations described with reference to FIGS. 1-3.

In some examples, the autonomous pentesting agent may obtain multiple shortest paths. For example, the autonomous pentesting agent may perform a query at a graph of the tenant environment for multiple shortest attack paths, such as a quantity of shortest attack paths. The autonomous pentesting agent may obtain an indication of the multiple shortest attack paths based on the query. The autonomous pentesting agent may attempt to execute autonomous pentesting operations corresponding to edges in an attack path of the multiple shortest attack paths with a lowest numerical quantity of edges prior to an attack path with a second lowest numerical quantity of edges, and so on. That is, the autonomous pentesting agent may use the multiple shortest attack paths for the autonomous pentest 405 in ascending order from lowest numerical quantity of edges to largest. In some examples, the autonomous pentesting agent may terminate the autonomous pentest 405 after a first successfully executed attack path. Alternatively, the autonomous pentesting agent may continue to execute attack paths (e.g., until all or a threshold quantity of the multiple shortest attack paths are attempted).

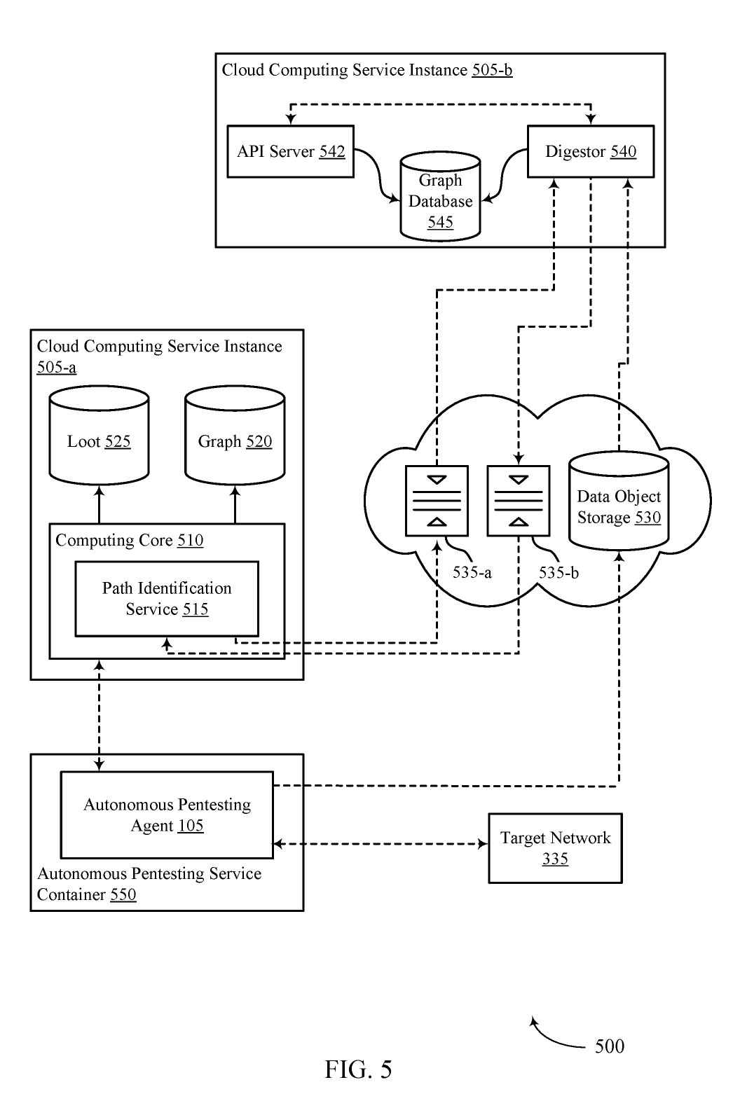

FIG. 5 shows an example of a computing environment 500 that supports autonomous pentesting utilizing shortest path analysis in accordance with aspects of the present disclosure. The computing environment 500 may implement or be implemented by the computing environment 100, the autonomous pentest map 200, the computing environment 300, the flow diagram 400, or any combination thereof. For example, the computing environment 500 may illustrate the integration of a path identification service 515 with an autonomous pentesting service.

The autonomous pentesting agent 105 may perform one or more operations described herein based on communication(s) with a path identification service 515 and associated components thereof. The path identification service 515 may be an example of BloodHound Community Edition (CE). For example, the path identification service 515 may be an example of an open-source service used to represent relationship structures via a graph 520 (e.g., a directed graph). The path identification service 515 may operate within a computing core 510 of a cloud computing service instance 505-a, such as an Amazon Elastic Compute Cloud (e.g., EC2). The cloud computing service instance 505-a may also include (e.g., store) the graph 520 and loot 525. The loot 525 may include information obtained during pentesting, including identifiers of network assets, information associated with network assets, network structure or configuration information, or the like.

The path identification service 515 may ingest various data (e.g., domain trusts, object properties, access control lists (ACLs), enumerated objects, enumerated memberships) and generate a directed graph (e.g., a graph that is directional or left-to-right where an attack may not be performed from a different direction). When the autonomous pentesting agent 105 obtains a domain credential, the autonomous pentesting agent 105 may run a collection module (e.g., a part of a collection or ingestion program) against a target service (e.g., an Active Directory or Entra ID environment) to collect raw data about the environment. The autonomous pentesting agent 105 may output the data in a JavaScript Object Notation (JSON) format and/or store the data in an archive (e.g., in a ZIP file).

The autonomous pentesting service container 550 may push the raw data to the data object storage 530 and relay a message to the computing core 510 that raw data is available to be processed. For example, the autonomous pentesting service container 550 may send a message including a bucket identifier and a hash of the raw data. The computing core 510 may receive the message and send a message to the digestor 540 via a simple queuing service (SQS) 535-a with the bucket identifier and the hash of the data. The digestor 540 may then download the data from the data object storage 530 (e.g., the S3 bucket) and post the data to the API server 542 for upload via a Representational State Transfer (REST) API.

The API server 542 of the cloud computing service instance 505-b may process and/or analyze the raw data and push the processed raw data to the graph database 545. For example, the API server 542 may obtain raw JSON data from the digestor 540, process and analyze the data, then build paths between objects (e.g., Active Directory or Entra ID objects). The API server 542 may write the processed version of the data to the graph database 545. After the API server 542 processes the data, the API server 542 may answer a REST API call from the digestor 540 with a message indicating that processing is complete. The digestor 540 may send a message to the computing core 510 via SQS 535-b indicating that the data has been processed and the computing core 510 is now able to query the graph database 545. For example, the computing core 510 may query the graph database 545 for information associated with attack paths (e.g., indication(s) of one or more shortest attack paths).

The one or more shortest attack paths may be computed by the computing core 510 and stored as part of the graph database 545 during the digestion process by the digestor 540, or dynamically computed by the API server 542 from the data in the graph database 545 in response to the message from the path identification service 515 via the SQS 535-a. Alternatively, the path identification service 515 may compute the one or more shortest attack paths using data from the graph database 545 supplied by the cloud computing service instance 505-b via the SQS 535-b.

The one or more shortest attack paths may be computed using, for example, using an algorithm associated with the shortest path problem, such as Dijkstra’s algorithm, the Bellman-Ford algorithm, or the A* search algorithm, the Floyd-Marshall algorithm, Johnson’s algorithm, and/or the Viterbi algorithm.

The autonomous pentesting agent 105 may obtain information associated with attack paths (e.g., indication(s) of one or more shortest attack paths) from the computing core 510. For example, the computing core 510 may send one or more indications of autonomous pentesting modules mapped to edges of one or more shortest attack paths to the autonomous pentesting agent 105. In some examples, the autonomous pentesting agent 105 may perform one or more operations described herein from an autonomous pentesting service container 550, based on the mapping of autonomous pentesting modules to edges of the one or more shortest attack paths, to perform an autonomous pentest of a target network 335, as discussed with reference to FIGS. 1-4.

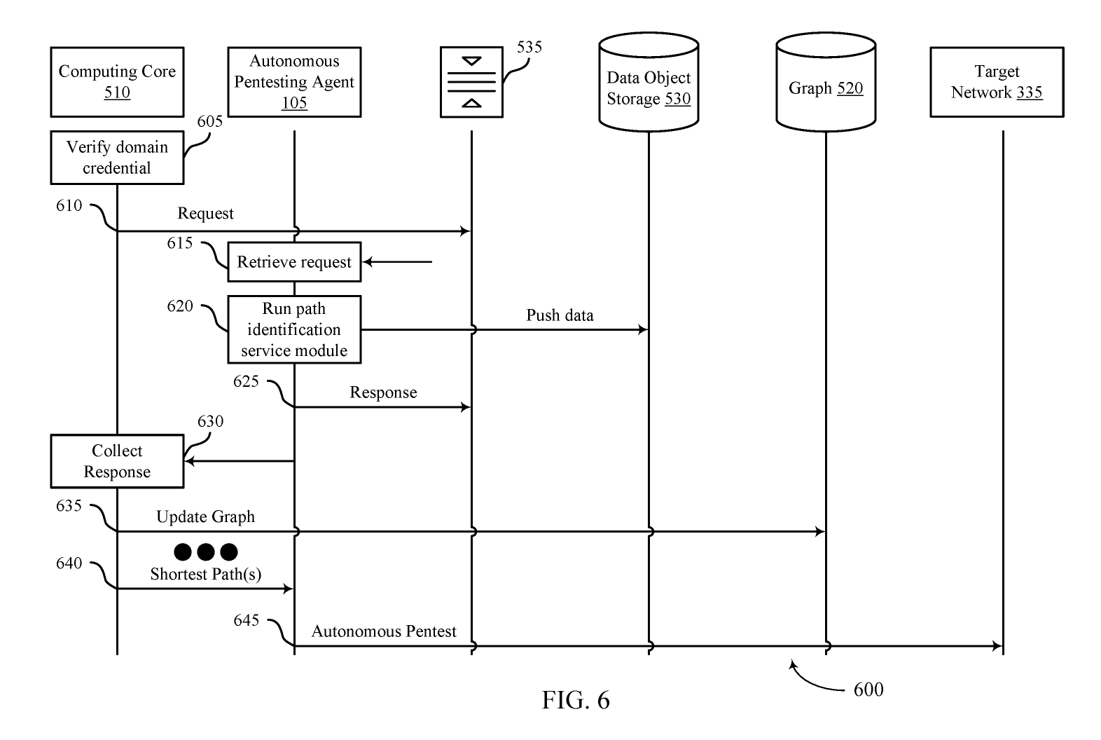

FIG. 6 shows an example of a process flow 600 that supports autonomous pentesting utilizing shortest path analysis in accordance with aspects of the present disclosure. The process flow 600 may implement or be implemented by the computing environment 100, the autonomous pentest map 200, the computing environment 300, the flow diagram 400, the computing environment 500, or any combination thereof. For example, the process flow 600 may illustrate operations between components of the computing environment 500.

Alternative examples of the following may be implemented, in which some operations are performed in a different order than described or are not performed at all. In some examples, operations may include additional features not mentioned below, or further operations may be added. Although the computing core 510, the autonomous pentesting agent 105, the SQS 535, the data object storage 530, and the graph 520 are shown performing the operations of the process flow 600, some aspects of some operations may also be performed by one or more other devices or systems.

At 605, the computing core 510 may verify a domain credential. When the computing core 510 verifies a new domain credential, it may attempt to run an ingestion procedure (e.g., bloodhound-python remote ingestor) against a domain controller with the credential using a module (e.g., bh_collect ubmodule). That is, the computing core 510 may execute a module to collect information about a user associated with the domain credential. After executing the module, at 610, the computing core 510 may send a request (e.g., ExecRequest) to the SQS 535 and, at 615, the autonomous pentesting agent 105 may retrieve (e.g., collect, such as via get_request()) the request from the SQS 535. The request (e.g., ExecRequestMessageBody) may include a flag allowing the computing core 510 to specify whether the output files of a command are to be uploaded to the data object storage 530, as opposed to the SQS 535 which may be utilized for smaller uploads.

At 620, the autonomous pentesting agent 105 may run a path identification service module (e.g., bloodhound-python) and upload the results to the data object storage 530 (e.g., an S3 bucket of an operation). This may allow the computing core 510 to reserve memory resources for other data that may be more useful for operations performed by the computing core 510. At 625, the autonomous pentesting agent 105 may send a response (e.g., ExecResponse) to the SQS 535 at 265, which may be retrieved (e.g., collected, such as via parse_response()) by the computing core 510 at 630. The computing core 510 may, at 635, update the graph 520 to include a new collection node corresponding to the domain credential. For example, the computing core 510 (e.g., by calling parse_response()) may create an entity in an operation graph with an attribute (e.g., a s3_id) including an identifier (e.g., an S3 resource uuid) of the output data.

In some examples, the computing core 510 may receive the same results (e.g., in the response) for multiple users unless a credential for a privileged user, such as a domain or local administrator, is obtained. However, the computing core 510 may still perform the operations of the process flow 600 to gain additional session information, as new users may have logged in while an operation has been running.

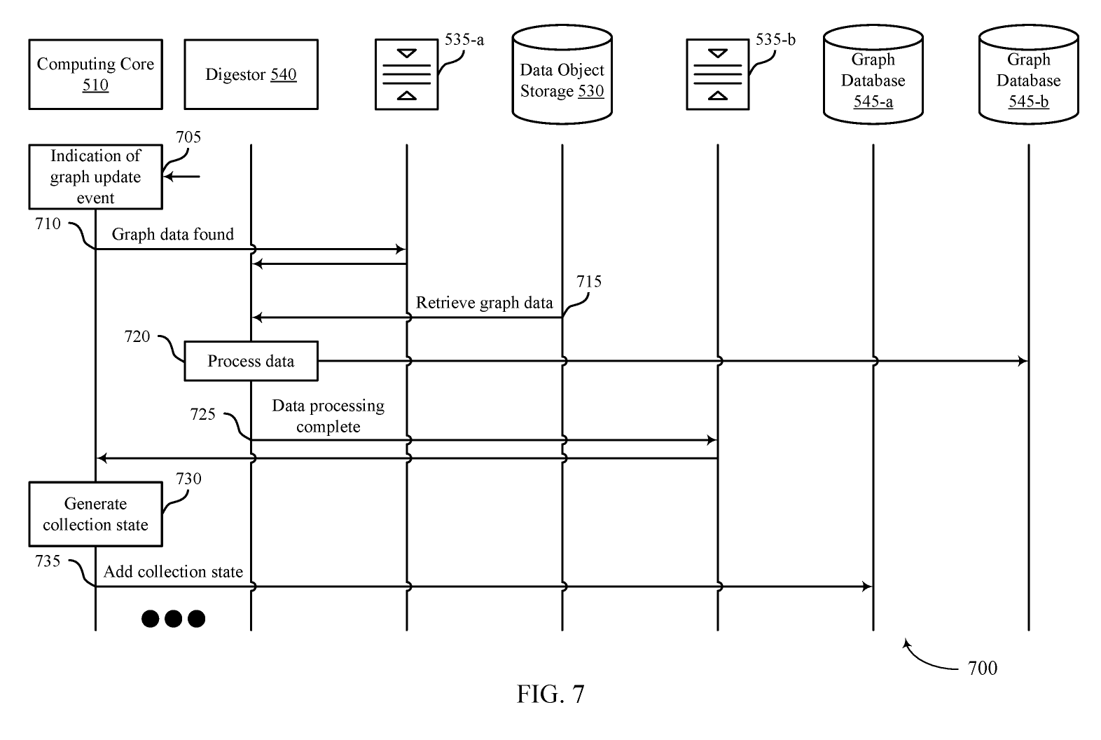

The computing core 510, autonomous pentesting agent 105, SQS 535, data object storage 530, and graph 520 may repeat the operations of FIG. 6 to collect graph data of multiple users of an environment, such as a tenant environment of a software platform. By collecting graph data for multiple users (and performing one or more additional operations described herein, such as the operations described with reference to FIG. 7), the computing core 510 may generate a representation (e.g., a directed graph) of the environment indicating relationships between users and relationships between network assets. The computing core 510 may use the representation to identify shortest path(s) between users and compromise events and autonomous pentesting operations associated with the shortest path(s).

For example, at 640, the autonomous pentesting agent 105 may obtain an indication of autonomous pentesting operations (e.g., procedures, tools, modules, etc.) corresponding to the shortest path(s) from the computing core 510. That is, the autonomous pentesting agent 105 may obtain, from the computing core 510, an indication of operations that correspond to an attack path between a user account and a compromise event. The computing core 510 may identify the attack path (e.g., a shortest path) from the user to the compromise event based on the representation generated based on collecting the graph data for the multiple users (and, in some examples, performing the operations of FIG. 7).

At 645, based on the autonomous pentesting operations obtained at 640, the autonomous pentesting agent 105 may perform an autonomous pentest on the target network 335. For example, the autonomous pentesting agent 105 may execute the autonomous pentesting operations based on the computing core 510 retrieving one or more mappings between edges of the shortest path(s) and autonomous pentesting operations and indicating the operations to the autonomous pentesting agent 105. In some examples, the autonomous pentesting agent 105 may execute operations corresponding to a next shortest attack path from the computing core 510, such as if the autonomous pentesting agent 105 fails to execute the autonomous pentesting operations mapped to the edges of the shortest path.

FIG. 7 shows an example of a process flow 700 that supports autonomous pentesting utilizing shortest path analysis in accordance with aspects of the present disclosure. The process flow 700 may implement or be implemented by the computing environment 100, the autonomous pentest map 200, the computing environment 300, the flow diagram 400, the computing environment 500, or any combination thereof. For example, the process flow 700 may illustrate operations between components of the computing environment 500. The operations of the process flow 700 may occur after the operations of the process flow 600.

Alternative examples of the following may be implemented, where some operations are performed in a different order than described or are not performed at all. In some examples, operations may include additional features not mentioned below, or further operations may be added. Although the computing core 510, the digestor 540, the SQS 535-a, the data object storage 530, the SQS 535-b, the graph database 545-a, and the graph database 545-b are shown performing the operations of the process flow 700, some aspects of some operations may also be performed by one or more other devices or systems.

At 705, the computing core 510 may receive an indication of a graph update event. For example, the computing core 510 may receive a ModuleOutput event, such as based on the operations of the process flow 600. At 710, the computing core 510 may send an indication of the graph data found to the digestor 540 via the SQS 535-a. For example, when a graph update occurs that includes a new entity, the computing core 510 may send a message the SQS 535-a including the identifier of (e.g., an s3_uuid) the data. The digestor 540 may receive the message via the SQS 535-a.

At 715, the digestor 540 may retrieve graph data from the data object storage 530, and, at 720, the digestor 540 may process and output the data to the graph database 545-b. For example, the digestor 540 may use the identifier of the data (e.g., the s3_uuid) to retrieve the files that are to be downloaded and processed. Once downloaded, the data may be passed to a thread or process via an InterProcess Communication (IPC) or via a "file placed in watch directory" approach.

At 725, the digestor 540 may indicate that the data processing is complete to the computing core 510 via the SQS 535-b. For example, after the files have been processed and the data has been added to the graph database 545-b, the digestor 540 may push a message to the SQS 535-b indicating the data has been processed. At 730, the computing core 510 may generate a collection state and, at 735, may add the collection state to the graph database 545-a. That is, the computing core 510 may update a processed status to be “true” at the graph database 545-a.

The computing core 510 may use the processed graph data to identify and output, to the autonomous pentesting agent 105, shortest path(s) between users and compromise events. For example, after processing the graph data according to the operations of FIG. 7, the autonomous pentesting agent 105 may transmit requests to the computing core 510 for shortest path(s). In some examples, the autonomous pentesting agent 105 may obtain the shortest path(s) from the computing core 510 based on the collection state at the graph database 545-a being “true.” In other words, the autonomous pentesting agent 105 may request shortest path(s) from a user to a compromise event based on identifying that graph data associated with the user is processed according to a processing status of data associated with the user in the graph database 545-b.

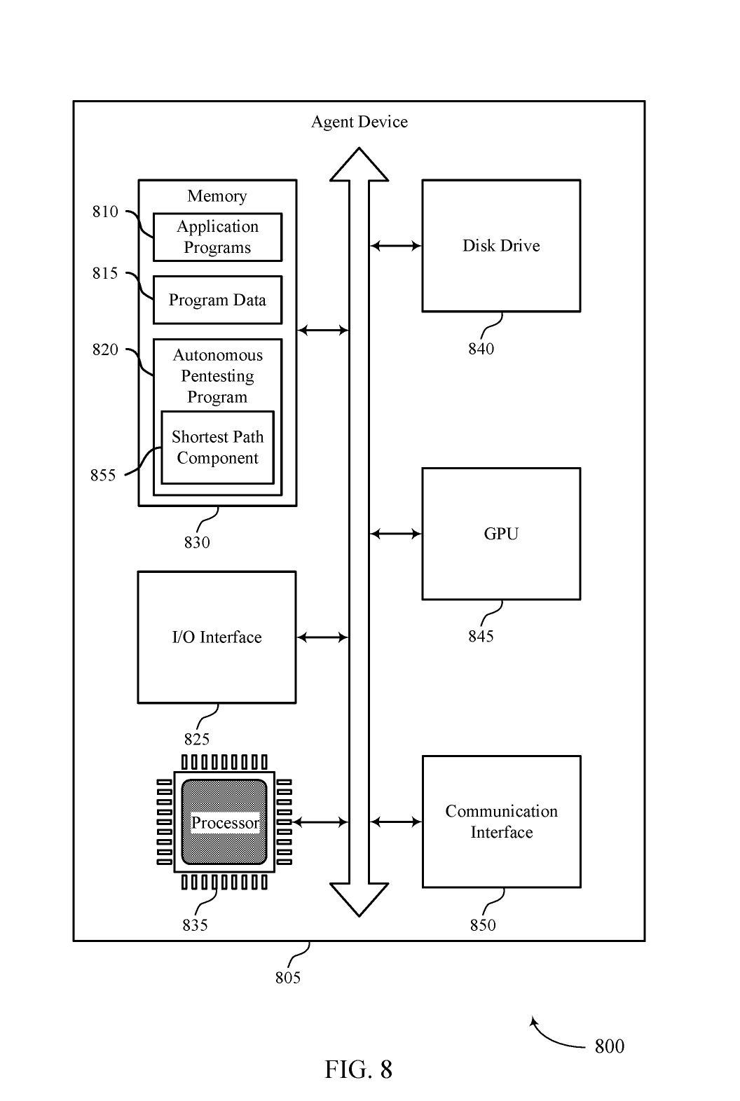

FIG. 8 shows a diagram of a system 800 including an agent device 805 that supports autonomous pentesting utilizing shortest path analysis in accordance with aspects of the present disclosure. The agent device 805 may be an example of a device or server on which an autonomous pentesting agent 105 is deployed as described herein. The agent device 805 may include components for autonomous pentesting utilizing shortest path analysis, such as a memory 830 including application programs 810, program data 815, an autonomous pentesting program 820, and a shortest path component 855; an input/output (I/O) interface 825; a processor 835; a disk drive 840; a graphics processing unit (GPU) 845; and a communication interface 850. Each of these components may communicate, directly or indirectly, with one another (e.g., via one or more buses, communications links, communications interfaces, or any combination thereof).

The I/O interface 825 may support connection of the agent device 805 with one or more other devices. For example, the agent device 805 may connect to keyboards, mice, printers, hard disks, or the like via the I/O interface 825. The I/O interface 825 may communicate with the processor 835. That is, the processor 835 may process signals from devices connected to the agent device 805 via the I/O interface 825.

Memory 830 may include RAM, ROM, or both. The memory 830 may store computer-readable, computer-executable software including instructions that, when executed, cause at least one processor 835 to perform various functions described herein, such as functions supporting autonomous pentesting utilizing shortest path analysis. In some cases, the memory 830 may contain, among other things, a basic input/output system (BIOS), which may control basic hardware or software operation such as the interaction with peripheral components or devices. The memory 830 may be an example of a single memory or multiple memories. For example, the agent device 805 may include one or more memories 830.

The application programs 810 in the memory 830 may be examples of app(s) 140 as described with reference to FIG. 1. For example, the application programs 810 may be installed on the memory 830 of the agent device 805, among other devices in a network. The application programs 810 may be examples of software applications or computer programs that are implemented to carry out one or more functions or tasks.

The program data 815 may be data related to the application programs 810. Program data 815 may be an example of or refer to running data of programs and applications installed on the memory 830 of the agent device 805. In some examples, the program data 815 may include various data, including code that allows the application programs 810 to perform the one or more functions or tasks.

The processor 835 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 835 may be configured to execute computer-readable instructions stored in at least one memory 830 to perform various functions (e.g., functions or tasks supporting autonomous pentesting utilizing shortest path analysis). Though a single processor 835 is depicted in the example of FIG. 8, it is to be understood that the system 800 may include any quantity of one or more of processors 835 and that a group of processors 835 may collectively perform one or more functions ascribed herein to a processor, such as the processor 835. The processor 835 may be an example of a single processor or multiple processors. For example, the agent device 805 may include one or more processors 835.

The disk drive 840 may be configured to store data that is generated, processed, stored, or otherwise used by the system 800. In some cases, the disk drive 840 may include one or more hard disk drives (HDDs), one or more solid-state drives (SSDs), or both. In some examples, the disk drive 840 may be an example of a single database, a distributed database, multiple distributed databases, a data store, a data lake, or an emergency backup database. In some examples, the disk drive 840 may be an example of one or more components described with reference to FIG. 1.

GPU 845 may be configured to store graphics-related data. The GPU 845 may store and manage data related to graphics and video processing. In some examples, the GPU 845 may be an example of or a component of a graphics card. The GPU 845 may use components of the memory 830, including the RAM, for temporary storage. For example, the GPU 845 may move data from the RAM of the memory 830 to the GPU 845 for graphics and video processing.

The communication interface 850 may enable the agent device 805 to exchange information (e.g., input information, output information, or both) with other systems or devices (not shown). For example, the communication interface 850 may enable the agent device 805 to connect to a network (e.g., a network 110 as described herein). The communication interface 850 may include one or more wireless network interfaces, one or more wired network interfaces, or any combination thereof.

The autonomous pentesting program 820 may be an example of a program of an autonomous pentesting service that is installed on the memory 830 of the agent device 805. The autonomous pentesting program 820 may execute an autonomous pentest of a network accessed by the agent device 805, such as accessed via the communication interface 850. That is, the autonomous pentesting program 820 may be configured to perform an autonomous pentest as described herein, including an autonomous pentest involving autonomous pentesting using shortest path analysis.

The shortest path component 855 may support autonomous pentesting using shortest path analysis in accordance with examples as disclosed herein. For example, the shortest path component 855 may be configured as or otherwise support a means for executing an autonomous pentest of a tenant environment of a software platform including a set of multiple network assets, where the autonomous pentest includes compromising a credential associated with a user account of the tenant environment.

The shortest path component 855 may be configured as or otherwise support a means for obtaining, based on compromising the credential, an indication of an attack path between the user account associated with the credential and a compromise event, the attack path indicating a sequence of network assets of the set of multiple network assets and one or more edges between network assets in the sequence of network assets, where the attack path is one of a set of multiple possible attack paths between the user account and the compromise event, each path of the set of multiple possible attack paths associated with different sequences of respective quantities of edges between network assets, and where the attack path includes a smallest numerical quantity of edges of the respective quantities of edges. The shortest path component 855 may be configured as or otherwise support a means for retrieving, based on receiving the indication of the attack path, one or more mappings between one or more autonomous pentesting operations and the one or more edges. The shortest path component 855 may be configured as or otherwise support a means for executing, based on retrieving the one or more mappings, the one or more autonomous pentesting operations in accordance with the attack path.

By including or configuring the shortest path component 855 in accordance with examples as described herein, the agent device 805 may support techniques for improved network security.

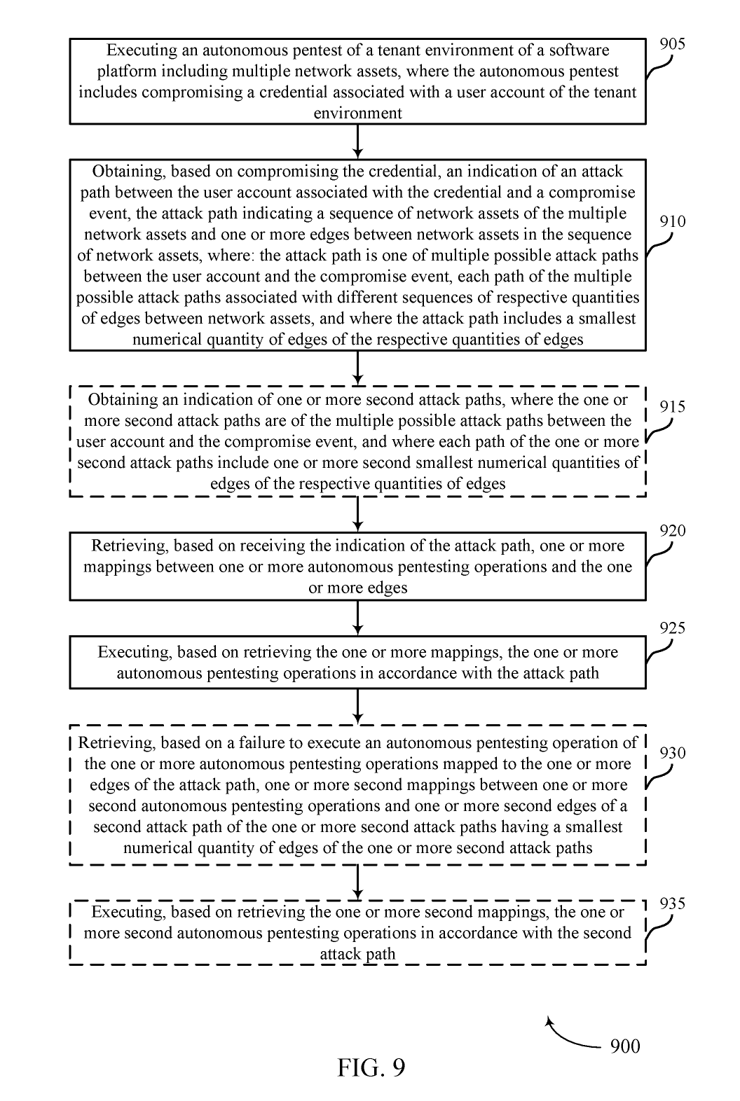

FIG. 9 shows a flowchart illustrating a method 900 that supports autonomous pentesting utilizing shortest path analysis in accordance with aspects of the present disclosure. The operations of the method 900 may be implemented by an agent device 805 or its components as described herein. In some examples, an agent device may execute a set of instructions to control the functional elements of the agent device to perform the described functions. Additionally, or alternatively, the agent device may perform aspects of the described functions using special-purpose hardware.

At 905, the method 900 may include executing an autonomous pentest of a tenant environment of a software platform including multiple network assets, where the autonomous pentest includes compromising a credential associated with a user account of the tenant environment.

At 910, the method 900 may include obtaining, based on compromising the credential, an indication of an attack path between the user account associated with the credential and a compromise event, the attack path indicating a sequence of network assets of the multiple network assets and one or more edges between network assets in the sequence of network assets, where: the attack path is one of multiple possible attack paths between the user account and the compromise event, each path of the multiple possible attack paths associated with different sequences of respective quantities of edges between network assets, and where the attack path includes a smallest numerical quantity of edges of the respective quantities of edges.

At 915, the method 900 may include obtaining an indication of one or more second attack paths, where the one or more second attack paths are of the multiple possible attack paths between the user account and the compromise event, and where each path of the one or more second attack paths include one or more second smallest numerical quantities of edges of the respective quantities of edges.

At 920, the method 900 may include retrieving, based on receiving the indication of the attack path, one or more mappings between one or more autonomous pentesting operations and the one or more edges.

At 925, the method 900 may include executing, based on retrieving the one or more mappings, the one or more autonomous pentesting operations in accordance with the attack path.

At 930, the method 900 may include retrieving, based on a failure to execute an autonomous pentesting operation of the one or more autonomous pentesting operations mapped to the one or more edges of the attack path, one or more second mappings between one or more second autonomous pentesting operations and one or more second edges of a second attack path of the one or more second attack paths having a smallest numerical quantity of edges of the one or more second attack paths.

At 935, the method 900 may include executing, based on retrieving the one or more second mappings, the one or more second autonomous pentesting operations in accordance with the second attack path.

The following provides an overview of aspects of the present disclosure:

Aspect 1: A method for autonomous pentesting using shortest path analysis, comprising: executing an autonomous pentest of a tenant environment of a software platform comprising a plurality of network assets, wherein the autonomous pentest includes compromising a credential associated with a user account of the tenant environment; obtaining, based at least in part on compromising the credential, an indication of an attack path between the user account associated with the credential and a compromise event, the attack path indicating a sequence of network assets of the plurality of network assets and one or more edges between network assets in the sequence of network assets, wherein: the attack path is one of a plurality of possible attack paths between the user account and the compromise event, each path of the plurality of possible attack paths associated with different sequences of respective quantities of edges between network assets, and the attack path comprises a smallest numerical quantity of edges of the respective quantities of edges; retrieving, based at least in part on receiving the indication of the attack path, one or more mappings between one or more autonomous pentesting operations and the one or more edges; and executing, based at least in part on retrieving the one or more mappings, the one or more autonomous pentesting operations in accordance with the attack path.

Aspect 2: The method of aspect 1, further comprising: obtaining an indication of one or more second attack paths, wherein the one or more second attack paths are of the plurality of possible attack paths between the user account and the compromise event, and wherein each path of the one or more second attack paths comprise one or more second smallest numerical quantities of edges of the respective quantities of edges.

Aspect 3: The method of aspect 2, further comprising: retrieving, based at least in part on a failure to execute an autonomous pentesting operation of the one or more autonomous pentesting operations mapped to the one or more edges of the attack path, one or more second mappings between one or more second autonomous pentesting operations and one or more second edges of a second attack path of the one or more second attack paths having a smallest numerical quantity of edges of the one or more second attack paths; and executing, based at least in part on retrieving the one or more second mappings, the one or more second autonomous pentesting operations in accordance with the second attack path.

Aspect 4: The method of any of aspects 1 through 3, further comprising: storing a file comprising a plurality of mappings between respective autonomous pentesting operations of a plurality of autonomous pentesting operations and respective edges of a plurality of edges between network assets, wherein the one or more mappings are retrieved from the stored file.

Aspect 5: The method of aspect 4, further comprising: determining the plurality of mappings between the respective autonomous pentesting operations and the respective edges between network assets based at least in part on receiving one or more inputs, performing the one or more autonomous pentesting operations, an output of a large language model (LLM), or any combination thereof.

Aspect 6: The method of any of aspects 1 through 5, wherein each autonomous pentesting operation of the one or more autonomous pentesting operations comprises one or more modules of executable code corresponding to an attack vector associated with a respective edge of the one or more edges between the network assets in the sequence of network assets.

Aspect 7: The method of any of aspects 1 through 6, wherein the tenant environment of the software platform comprises an Active Directory tenant environment, a Microsoft Entra ID tenant environment, or an Azure Active Directory tenant environment.

Aspect 8: The method of any of aspects 1 through 7, further comprising: transmitting, to an API server, an API request for a shortest attack path based at least in part on compromising the credential associated with the user account, wherein the request includes an indication of the user account, wherein obtaining the indication of the attack path comprises receiving the indication based at least in part on the API request.

Aspect 9: The method of any of aspects 1 through 8, further comprising: terminating the autonomous pentest after executing the one or more autonomous pentesting operations.

Aspect 10: The method of any of aspects 1 through 9, further comprising: achieving the compromise event based at least in part on successfully executing the one or more autonomous pentesting operations in accordance with the attack path.

Aspect 11: An apparatus for autonomous pentesting using shortest path analysis, comprising: one or more memories storing processor-executable code; and one or more processors coupled with the one or more memories and individually or collectively operable to execute the code to cause the apparatus to perform a method of any of aspects 1 through 10.

Aspect 12: A non-transitory computer-readable medium storing code for autonomous pentesting using shortest path analysis, the code comprising instructions executable by one or more processors to perform a method of any of aspects 1 through 10.

Aspect 13: An apparatus for autonomous pentesting using shortest path analysis, comprising at least one means for performing a method of any aspects 1 through 10.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for autonomous pentesting using shortest path analysis, comprising:
executing an autonomous pentest of a tenant environment of a software platform comprising a plurality of network assets, wherein the autonomous pentest includes compromising a credential associated with a user account of the tenant environment;
obtaining, based at least in part on compromising the credential, an indication of an attack path between the user account associated with the credential and a compromise event, the attack path indicating a sequence of network assets of the plurality of network assets and one or more edges between network assets in the sequence of network assets, wherein:
the attack path is one of a plurality of possible attack paths between the user account and the compromise event, each path of the plurality of possible attack paths associated with different sequences of respective quantities of edges between network assets, and
the attack path comprises a smallest numerical quantity of edges of the respective quantities of edges;
retrieving, based at least in part on receiving the indication of the attack path, one or more mappings between one or more autonomous pentesting operations and the one or more edges; and
executing, based at least in part on retrieving the one or more mappings, the one or more autonomous pentesting operations in accordance with the attack path.

2. The method of claim 1, further comprising:
obtaining an indication of one or more second attack paths, wherein the one or more second attack paths are of the plurality of possible attack paths between the user account and the compromise event, and wherein each path of the one or more second attack paths comprise one or more second smallest numerical quantities of edges of the respective quantities of edges.

3. The method of claim 2, further comprising:
retrieving, based at least in part on a failure to execute an autonomous pentesting operation of the one or more autonomous pentesting operations mapped to the one or more edges of the attack path, one or more second mappings between one or more second autonomous pentesting operations and one or more second edges of a second attack path of the one or more second attack paths having a smallest numerical quantity of edges of the one or more second attack paths; and
executing, based at least in part on retrieving the one or more second mappings, the one or more second autonomous pentesting operations in accordance with the second attack path.

4. The method of claim 1, further comprising:
storing a file comprising a plurality of mappings between respective autonomous pentesting operations of a plurality of autonomous pentesting operations and respective edges of a plurality of edges between network assets, wherein the one or more mappings are retrieved from the stored file.

5. The method of claim 4, further comprising:
determining the plurality of mappings between the respective autonomous pentesting operations and the respective edges between network assets based at least in part on receiving one or more inputs, performing the one or more autonomous pentesting operations, an output of a large language model (LLM), or any combination thereof.

6. The method of claim 1, wherein each autonomous pentesting operation of the one or more autonomous pentesting operations comprises one or more modules of executable code corresponding to an attack vector associated with a respective edge of the one or more edges between the network assets in the sequence of network assets.

7. The method of claim 1, wherein the tenant environment of the software platform comprises an Active Directory tenant environment, a Microsoft Entra ID tenant environment, or an Azure Active Directory tenant environment.

8. The method of claim 1, further comprising:
transmitting, to an application programming interface (API) server, an API request for a shortest attack path based at least in part on compromising the credential associated with the user account, wherein the request includes an indication of the user account, wherein obtaining the indication of the attack path comprises receiving the indication based at least in part on the API request.

9. The method of claim 1, further comprising:
terminating the autonomous pentest after executing the one or more autonomous pentesting operations.

10. The method of claim 1, further comprising:
achieving the compromise event based at least in part on successfully executing the one or more autonomous pentesting operations in accordance with the attack path.

11. An apparatus for autonomous pentesting using shortest path analysis, comprising:
one or more memories storing processor-executable code; and
one or more processors coupled with the one or more memories and individually or collectively operable to execute the code to cause the apparatus to:
execute an autonomous pentest of a tenant environment of a software platform comprising a plurality of network assets, wherein the autonomous pentest includes compromising a credential associated with a user account of the tenant environment;
obtain, based at least in part on compromising the credential, an indication of an attack path between the user account associated with the credential and a compromise event, the attack path indicating a sequence of network assets of the plurality of network assets and one or more edges between network assets in the sequence of network assets, wherein:
the attack path is one of a plurality of possible attack paths between the user account and the compromise event, each path of the plurality of possible attack paths associated with different sequences of respective quantities of edges between network assets, and
the attack path comprises a smallest numerical quantity of edges of the respective quantities of edges;
retrieve, based at least in part on receiving the indication of the attack path, one or more mappings between one or more autonomous pentesting operations and the one or more edges; and
execute, based at least in part on retrieving the one or more mappings, the one or more autonomous pentesting operations in accordance with the attack path.

12. The apparatus of claim 11, wherein the one or more processors are individually or collectively further operable to execute the code to cause the apparatus to:
obtain an indication of one or more second attack paths, wherein the one or more second attack paths are of the plurality of possible attack paths between the user account and the compromise event, and wherein each path of the one or more second attack paths comprise one or more second smallest numerical quantities of edges of the respective quantities of edges.

13. The apparatus of claim 12, wherein the one or more processors are individually or collectively further operable to execute the code to cause the apparatus to:
retrieve, based at least in part on a failure to execute an autonomous pentesting operation of the one or more autonomous pentesting operations mapped to the one or more edges of the attack path, one or more second mappings between one or more second autonomous pentesting operations and one or more second edges of a second attack path of the one or more second attack paths having a smallest numerical quantity of edges of the one or more second attack paths; and
execute, based at least in part on retrieving the one or more second mappings, the one or more second autonomous pentesting operations in accordance with the second attack path.

14. The apparatus of claim 11, wherein the one or more processors are individually or collectively further operable to execute the code to cause the apparatus to:
store a file comprising a plurality of mappings between respective autonomous pentesting operations of a plurality of autonomous pentesting operations and respective edges of a plurality of edges between network assets, wherein the one or more mappings are retrieved from the stored file.

15. The apparatus of claim 14, wherein the one or more processors are individually or collectively further operable to execute the code to cause the apparatus to:
determine the plurality of mappings between the respective autonomous pentesting operations and the respective edges between network assets based at least in part on receiving one or more inputs, performing the one or more autonomous pentesting operations, an output of a large language model (LLM), or any combination thereof.

16. A non-transitory computer-readable medium storing code for autonomous pentesting using shortest path analysis, the code comprising instructions executable by one or more processors to:
execute an autonomous pentest of a tenant environment of a software platform comprising a plurality of network assets, wherein the autonomous pentest includes compromising a credential associated with a user account of the tenant environment;
obtain, based at least in part on compromising the credential, an indication of an attack path between the user account associated with the credential and a compromise event, the attack path indicating a sequence of network assets of the plurality of network assets and one or more edges between network assets in the sequence of network assets, wherein:
the attack path is one of a plurality of possible attack paths between the user account and the compromise event, each path of the plurality of possible attack paths associated with different sequences of respective quantities of edges between network assets, and
the attack path comprises a smallest numerical quantity of edges of the respective quantities of edges;
retrieve, based at least in part on receiving the indication of the attack path, one or more mappings between one or more autonomous pentesting operations and the one or more edges; and
execute, based at least in part on retrieving the one or more mappings, the one or more autonomous pentesting operations in accordance with the attack path.

17. The non-transitory computer-readable medium of claim 16, wherein the instructions are further executable by the one or more processors to:
obtain an indication of one or more second attack paths, wherein the one or more second attack paths are of the plurality of possible attack paths between the user account and the compromise event, and wherein each path of the one or more second attack paths comprise one or more second smallest numerical quantities of edges of the respective quantities of edges.

18. The non-transitory computer-readable medium of claim 17, wherein the instructions are further executable by the one or more processors to:
retrieve based at least in part on a failure to execute an autonomous pentesting operation of the one or more autonomous pentesting operations mapped to the one or more edges of the attack path, one or more second mappings between one or more second autonomous pentesting operations and one or more second edges of a second attack path of the one or more second attack paths having a smallest numerical quantity of edges of the one or more second attack paths; and
execute, based at least in part on retrieving the one or more second mappings, the one or more second autonomous pentesting operations in accordance with the second attack path.

19. The non-transitory computer-readable medium of claim 16, wherein the instructions are further executable by the one or more processors to:
store a file comprising a plurality of mappings between respective autonomous pentesting operations of a plurality of autonomous pentesting operations and respective edges of a plurality of edges between network assets, wherein the one or more mappings are retrieved from the stored file.

20. The non-transitory computer-readable medium of claim 19, wherein the instructions are further executable by the one or more processors to:
determine the plurality of mappings between the respective autonomous pentesting operations and the respective edges between network assets based at least in part on receiving one or more inputs, performing the one or more autonomous pentesting operations, an output of a large language model (LLM), or any combination thereof.
